(19) United States
(12) Patent Application Publication
(10) Pub. No.: US 2014/0019911 A1
(43) Pub. Date: Jan. 16, 2014

(54) DISPLAY CONTROL APPARATUS AND METHOD FOR CONTROLLING DISPLAY CONTROL APPARATUS

(71) Applicant: Canon Kabushiki Kaisha, Tokyo (JP)

(72) Inventor: Takashi Yoshimi, Kawasaki-shi (JP)

(21) Appl. No.: 13/938,621

(22) Filed: Jul. 10, 2013

(30) Foreign Application Priority Data
Jul. 11, 2012 (JP) 2012-155510

(51) Int. Cl. G06F 3/0482

(52) U.S. Cl. CPC G06F 3/0482
USPC 715/810

(57) ABSTRACT

A display control apparatus can receive an instruction to switch selection to a first direction and a second direction, and perform control to, in response to an instruction to switch the selection to the first direction, from among display items included in a succeeding row, select a second display item a position in a second axial direction parallel to the second direction of which is closest to a position in the second axial direction of a first display item that is first selected, and, when a second instruction to switch the selection to the first direction is further issued from a state where the second display item is selected, select a display item a position in the second axial direction of which is closest to the position in the second axial direction of the first display item from among the display items included in a further succeeding row.

### BACKGROUND OF THE INVENTION

1. Field of the Invention

The present invention relates to a display control apparatus, a method for controlling the display control apparatus, a program, and a recording medium, and more particularly, to a technique in switching, from among a plurality of display items displayed on a display unit, a display item to be selected into another display item.

2. Description of the Related Art

A technique for selecting, from among display items such as a plurality of images, icons, and virtual buttons which are displayed on a display, a desired display item by sequentially switching the display item to be selected using an operation member such as a cross key has been discussed.

Japanese Patent Application Laid-Open No. 2011-034467 discusses a cursor operation apparatus which is configured to stop a cursor at positions of a plurality of clickable objects (display items) and positions of intersections of a vertical line and a horizontal line passing through each of the clickable objects and a current cursor position.

Consider a case of selecting, in response to a press of any one of buttons included in a cross key that can be operated in upward, downward, rightward and leftward directions, a display item closest in a direction of the pressed button to a currently selected display item from among a plurality of display items displayed without being aligned in a matrix. A case where the display items are not aligned in a matrix includes a state where positions in a row direction of the display items are shifted from one another as viewed in a column direction, a state where positions in a column direction are shifted from one another as viewed in a row direction, and a case where the display items are arranged in a dispersed manner regardless of rows and columns. In such a case, when a down button is pressed a plurality of times to switch the selection, for example, the display item is shifted in position in a rightward and leftward direction from the display item first selected. Then, even if an up button on the same axis as the down button is pressed many times, the display item which has first been selected may not be selectable again. In addition, when the lowermost display item is selected, and the selection is then repeated from the uppermost display item again, the display item that differs for each circulation may be selected.

a specific example will be described using a soft keyboard resembling a hardware keyboard illustrated in FIG. 8A. If a down button is pressed while a “y” key is selected, as illustrated in FIG. 8A, when selection is moved, among keys one stage below the “y” key previously selected, to a key closest to the center of the “y” key, a “g” key is selected, as illustrated in FIG. 8B. Similarly, the selection is moved, among keys one stage below the key previously selected, to a key closest to the center of the key previously selected in response to the press of the down button. Consequently, every time the down button is pressed, the selection is switched to the “g” key (FIG. 8B), a “v” key (FIG. 8C), and a space key (FIG. 8D) in this order.

Whereas if an up button is pressed this time while the space key is selected (FIG. 8D), and the selection is moved, among keys one stage above the space key previously selected, to the key closest to the center of the space key, a “c” key is selected, as illustrated in FIG. 8E. Similarly, the selection is moved, among keys one stage above the key previously selected, to a key closest to the center of the key previously selected in response to the press of the up button. Consequently, every time the up button is pressed, the selection is switched to the “c” key (FIG. 8E), an “f” key (not illustrated), and a “t” key (FIG. 8F) in this order. As described above, when the selection returns to the same stage, although only buttons on the same axis, i.e., the up button and the down button are operated from a state where the “y” key has first been selected, the “t” key, which differs from the initial “y” key, is selected. To return the selection to the initial “y” key from this state, the right button needs to be pressed.

When the down button is further pressed while the space key is selected (FIG. 8D), an “r” key is selected (not illustrated) when the selection is moved, among keys in a stage at an opposite end (an upper end) of the space key previously selected, to the key closest to the center of the space key. As described above, when the selection returns to the same stage, although only the same button, i.e., the down button is operated from a state where the “y” key has first been selected, the “r” key which differs from the initial “y” key is selected. To return the selection to the initial “y” key from this state, the right button needs to be pressed two times.

The key previously selected cannot be selected again by an operation in the same axial direction (in an upward and downward direction) regardless of only an operation in the same axial direction being performed. An operation in another axial direction (in a rightward and leftward direction) may be required to be performed. Such an operation may be hard for a user to understand.

On the other hand, when a selection cursor is moved according to the method discussed in Japanese Patent Application Laid-Open No. 2011-034467, the selection cursor is moved to a position other than a display item. Thus, the number of operations to be performed may increase until a desired display item is selected because the selection cursor passes through a position other than the display item.

### SUMMARY OF THE INVENTION

The present invention is directed to a technique for enabling a display item previously selected in a continuous operation process in the same axial direction to be simply selected again from among a plurality of display items by an operation in the same axial direction without performing an operation in another axial direction.

According to an aspect of the present invention, a display control apparatus includes a display control unit configured to display a plurality of selectable display items side by side for each row, a receiving unit configured to be able to receive an instruction to switch, from among the plurality of display items, selection from a display item currently selected to another display item in a first direction parallel to a first axial direction and an instruction to switch the selection from the display item currently selected to another display item in a second direction parallel to a second axial direction not parallel to the first axial direction, and a control unit configured to perform control to, in a case where a first instruction to switch the selection to the first direction is issued, from among display items included in a row succeeding a row in which a first display item which is selected before the first instruction is received is displayed, select a second display item a position in the second axial direction of which is closest to a position in the second axial direction of the first display item, and in a case where a second instruction to switch the selection to the first direction is issued without an instruction to switch the selection to the second direction being issued from a state where the second display item is selected in response to the first instruction, select a display item a position in the second axial direction of which is closest to a position in the second axial direction of the first display item from among the display items included in a row succeeding a row in which the second display item is displayed.

According to the present invention, the display item previously selected in the continuous operation process in the same axial direction can be simply selected again from among the plurality of display items by the operation in the same axial direction without performing the operation in the other axis direction.

Further features of the present invention will become apparent from the following description of exemplary embodiments with reference to the attached drawings.

### BRIEF DESCRIPTION OF THE DRAWINGS

FIG. 1 is a back side external view of a digital camera 100.

FIG. 2 is a block diagram illustrating a configuration of the digital camera 100.

FIG. 3 (including FIGS. 3A and 3B) is a flowchart of character input processing according to a first exemplary embodiment of the present invention.

FIG. 4 illustrates a focus movement rule according to the first exemplary embodiment of the present invention.

FIG. 5 is a flowchart of character input processing according to a second exemplary embodiment of the present invention.

FIG. 6 illustrates a focus movement rule according to the second exemplary embodiment of the present invention.

FIG. 7A illustrates an example of display of a soft keyboard according to each of the exemplary embodiments of the present invention, and FIG. 7B illustrates data pieces StartX, StartY, StartW, and StartH according to the present exemplary embodiment.

FIGS. 8A to 8H illustrate examples of display of a soft keyboard according to each of the exemplary embodiments of the present invention.

### DESCRIPTION OF THE EMBODIMENTS

Exemplary embodiments of the present invention will be described in detail below with reference to the accompanying drawings. It is to be noted that the following exemplary embodiments are merely examples for implementing the present invention and can be appropriately modified or changed depending on individual constructions and various conditions of apparatuses to which the present invention is applied. Thus, the present invention is in no way limited to the following exemplary embodiments.

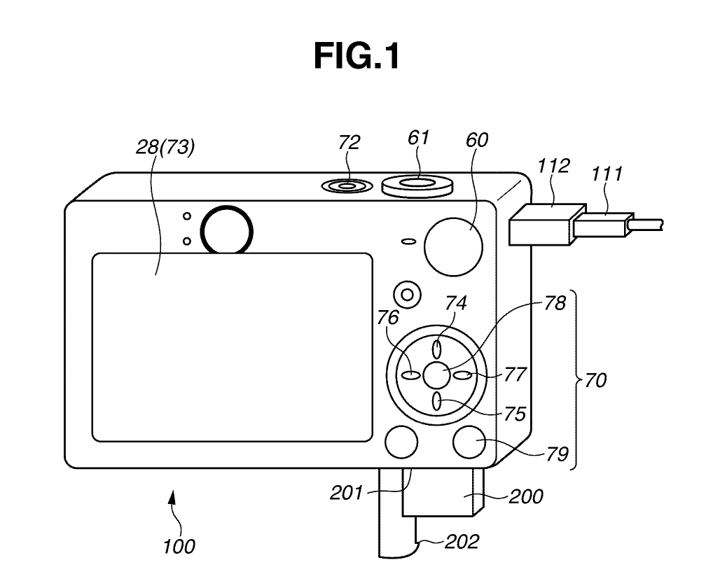

FIG. 1 is an external view of a digital camera 100 as an example of a display control apparatus according to the present invention. A display unit 28 displays images and various types of information. A shutter button 61 is an operation unit for issuing a shooting instruction. A mode changing switch 60 is an operation unit for switching various types of modes. A connector 112 is a connector between a connection cable and the digital camera 100. An operation unit 70 includes operation members such as various types of switches and buttons, and a touch panel 73, which respectively receive various types of operations from a user. The touch panel 73 is an operation member included in the operation unit 70, and is integrated with the display unit 28. A power switch 72 is a button for switching between power ON and power OFF. A recording medium 200 includes a memory card, a hard disk, and the like. A recording medium slot 201 is a slot for storing the recording medium 200. The recording medium 200 stored in the recording medium slot 201 can communicate with the digital camera 100. A cover 202 is a cover of the recording medium slot 201.

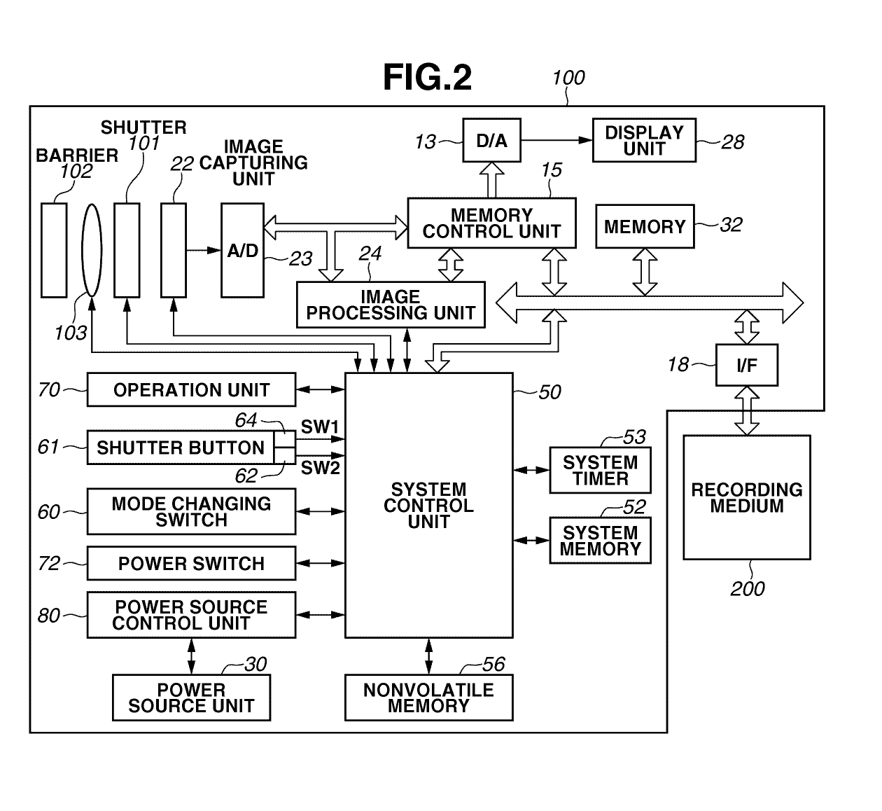

FIG. 2 is a block diagram illustrating an example of a configuration of the digital camera 100 according to the present exemplary embodiment.

In FIG. 2, a shooting lens 103 is a lens group including a zoom lens and a focus lens. A shutter 101 includes a shutter having a diaphragm function. An image capturing unit 22 is an image sensor including a charge coupled device (CCD), a complementary metal oxide semiconductor (CMOS), and the like which converts an optical image into an electrical signal. An analog-to-digital (A/D) converter 23 converts an analog signal into a digital signal. The A/D converter 23 is used to convert an analog signal output from the image capturing unit 22 into a digital signal. A barrier 102 covers an image capturing system including the shooting lens 103 in the digital camera 100 to prevent the image capturing system including the shooting lens 103, the shutter 101, and the image capturing unit 22 from being contaminated or damaged.

An image processing unit 24 performs resize processing such as predetermined pixel interpolation and reduction and color conversion processing on data from the A/D converter 23 or data from a memory control unit 15. The image processing unit 24 performs predetermined calculation processing using data of a captured image, and a system control unit 50 performs exposure control and range-finding control based on an obtained calculation result. Thus, automatic focus (AF) processing of a through the lens (TTL) method, automatic exposure (AE) processing, and flash pre-emission (EF) processing are performed. The image processing unit 24 further performs predetermined calculation processing using data of a captured image, and also performs automatic white balance (AWB) processing of the TTL method based on an obtained calculation result.

The output data from the A/D converter 23 is directly written into a memory 32 via the image processing unit 24 and the memory control unit 15 or via the memory control unit 15. The memory 32 stores image data obtained by the image capturing unit 22 and converted into digital data by the A/D converter 23 and image data to be displayed on the display unit 28. The memory 32 has a sufficient storage capacity to store a predetermined number of still images and a moving image and audio for a predetermined period of time.

The memory 32 is also used as a memory for image display (a video memory). A digital-to-analog (D/A) converter 13 converts data for image display stored in the memory 32 into an analog signal, and supplies the analog signal to the display unit 28. Thus, the display unit 28 displays the data for image display which has been written into the memory 32 via the D/A converter 13. The display unit 28 performs display on a display such as a liquid crystal display (LCD) in response to the analog signal from the D/A converter 13. The D/A converter 13 converts the digital signal which has been obtained by single A/D conversion in the A/D converter 23 and stored in the memory 32 into an analog signal, and sequentially transfers and displays the analog signal on the display unit 28. Therefore, the display unit 28 functions as an electronic view finder, and can perform through-the-lens image display.

A nonvolatile memory 56 is an electrically erasable and recordable memory, and includes an electrically erasable and programmable read only memory (EEPROM), for example. The nonvolatile memory 56 stores constants, programs, and others to be used in operations of the system control unit 50. The programs are used for executing various types of flowcharts, described below, according to the present exemplary embodiment.

The system control unit 50 controls the entire digital camera 100. The system control unit 50 implements each processing according to the present exemplary embodiment, described below, by executing the programs recorded in the nonvolatile memory 56, described above. A system memory 52 includes a random access memory (RAM). Constants and variables to be used in operations of the system control unit 50, and the program read from the nonvolatile memory 56 are rasterized into the system memory 52. The system control unit 50 also performs display control by controlling the memory 32, the D/A converter 13, the display unit 28, and the like.

A system timer 53 is a time measurement unit that measures a time used for various types of control and a time of a built-in clock.

A mode changing switch 60, a first shutter switch 62, a second shutter switch 64, and an operation unit 70 are operation units for inputting various types of operation instructions into the system control unit 50.

The mode changing switch 60 switches an operation mode of the system control unit 50 into any one of a still image recording mode, a moving image recording mode, and a reproduction mode. Modes included in the still image recording mode are an automatic shooting mode, an automatic scene determination mode, a manual mode, various types of scene modes serving as shooting settings for each shooting scene, a program AE mode, a custom mode, and so on. The mode changing switch 60 directly switches the operation mode of the system control unit 50 to any one of the modes included in the still image recording mode. Alternatively, the mode changing switch 60 may switch the operation mode of the system control unit 50 into the still image recording mode once, and then switch the still image recording mode into any one of the modes included in the still image recording mode using another operation member. Similarly, the moving image recording mode may include a plurality of modes. The first shutter switch 62 is turned ON while the shutter button 61 provided in the digital camera 100 is being operated, by a half-pressed state (a shooting preparation instruction), to generate a first shutter switch signal SW1. Operations such as AF processing, AE processing, AWB processing, EF processing, and the like are started in response to the first shutter switch signal SW1.

The second shutter switch 64 is turned ON when the operation of the shutter button 61 is completed, by a full-pressed state (a shooting instruction), to generate a second shutter switch signal SW2. The system control unit 50 starts to perform a series of operations for shooting processing from read out of a signal from the image capturing unit 22 until image data is written into a recording medium 200 in response to the second shutter switch SW2.

The operation members in the operation unit 70 are respectively assigned functions, as needed, for each scene by selectively operating various types of function icons displayed on the display unit 28, for example, and respectively function as various types of function buttons. The operation unit 70 includes the touch panel 73, an up button 74, a down button 75, a left button 76, a right button 77, a set button 78, and a menu button 79. When the menu button 79 is pressed, for example, a menu screen for performing various types of settings is displayed on the display unit 28. A user can intuitively perform various types of settings using the menu screen displayed on the display unit 28, a cross key, the set button 78, and the touch panel 73. The up button 74 and the down button 75 are generically referred to as an up/down key. The left button 76 and the right button 77 are generically referred to as a right/left key. The up button 74, the down button 75, the left button 76, and the right button 77 are generically referred to as a cross key. The cross key can receive an operation in four upward, downward, leftward, and rightward directions. The up/down key is an operation member that can receive an operation instruction in an upward and downward axial direction, and the right/left key is an operation member that can receive an operation instruction in a rightward and leftward axial direction. The up/down key and the right/left key can issue the operation instructions in the axial directions that are not parallel to each other.

A power source control unit 80 includes a battery detection circuit, a direct current-direct current (DC-DC) converter, a switch circuit for switching a block to be energized, and the like, and detects the presence or absence of mounting of a battery, the type of the battery, and a remaining battery capacity. The power control unit 80 controls the DC-DC converter based on a detection result and an instruction issued by the system control unit 50, and supplies a required voltage to each of units including a recording medium 200 in a required period of time.

A power source unit 30 includes a primary battery such as an alkaline battery, or a lithium (Li) battery, a secondary battery such as a nickel-cadmium (NiCd) battery, a nickel metal hydride (NiMH) battery, or an Li battery, an alternating current (AC) adaptor, and the like. A recording medium interface (I/F) 18 is an interface with the recording medium 200 such as a memory card or a hard disk. The recording medium 200 is a recording medium such as a memory card for recording a captured image, and includes a semiconductor memory or a magnetic disk.

The touch panel 73 and the display unit 28 can be integrated with each other. For example, the touch panel 73 has its light transmittance not preventing display on the display unit 28, and is attached to an upper layer of a display surface of the display unit 28. An input coordinate in the touch panel 73 and a display coordinate on the display unit 28 are associated with each other. Thus, a graphical user interface (GUI) can be configured as if a user could directly operate a screen displayed on the display unit 28. The system control unit 50 can detect operations and states, described below, on the touch panel 73;
An operation to touch the touch panel 73 with a finger or a pen (hereinafter referred to as “touch-down”).
A state where the touch panel 73 is touched with a finger or a pen (hereinafter referred to as “touch-on”).
A state where a finger or a pen is moving while the touch panel 73 is touched therewith (hereinafter referred to as “move”).
An operation to release a finger or a pen with which the touch panel 73 has been touched (hereinafter referred to as “touch-up”).
A state where the touch panel 73 is touched with nothing (hereinafter referred to as “touch-off”).

The operations and the states and position coordinates at which the touch panel 73 is touched with a finger or a pen are notified to the system control unit 50 via an internal bus 111. The system control unit 50 determines what operation has been performed on the touch panel 73 based on the notified information. For “move”, a movement direction of the finger or the pen that moves on the touch panel 73 can be determined for each vertical component and horizontal component on the touch panel 73 based on a change in the position coordinates. When “touch-up” has been performed via predetermined “move” from “touch-down” on the touch panel 73, it is regarded that a stroke has been drawn. An operation to quickly draw a stroke is referred to as “flick”. “Flick” is an operation to quickly move the finger by a certain distance while the touch panel 73 is touched therewith and release the finger, i.e., an operation to quickly trace the touch panel 73 to flick the touch panel 73. The system control unit 50 can determine, when “move” over a predetermined distance or more at a predetermined speed or more has been detected, and “touch-up” has been directly detected, that “flick” has been performed. The system control unit 50 determines, when “move” over a predetermined distance or more at a predetermined speed or less has been detected, that a drag has been performed. The touch panel 73 may include any one of touch panels of various types such as a resistance film type, an electrostatic capacitance type, a surface acoustic wave type, an infrared ray type, an electromagnetic induction type, an image recognition type, and an optical sensor type.

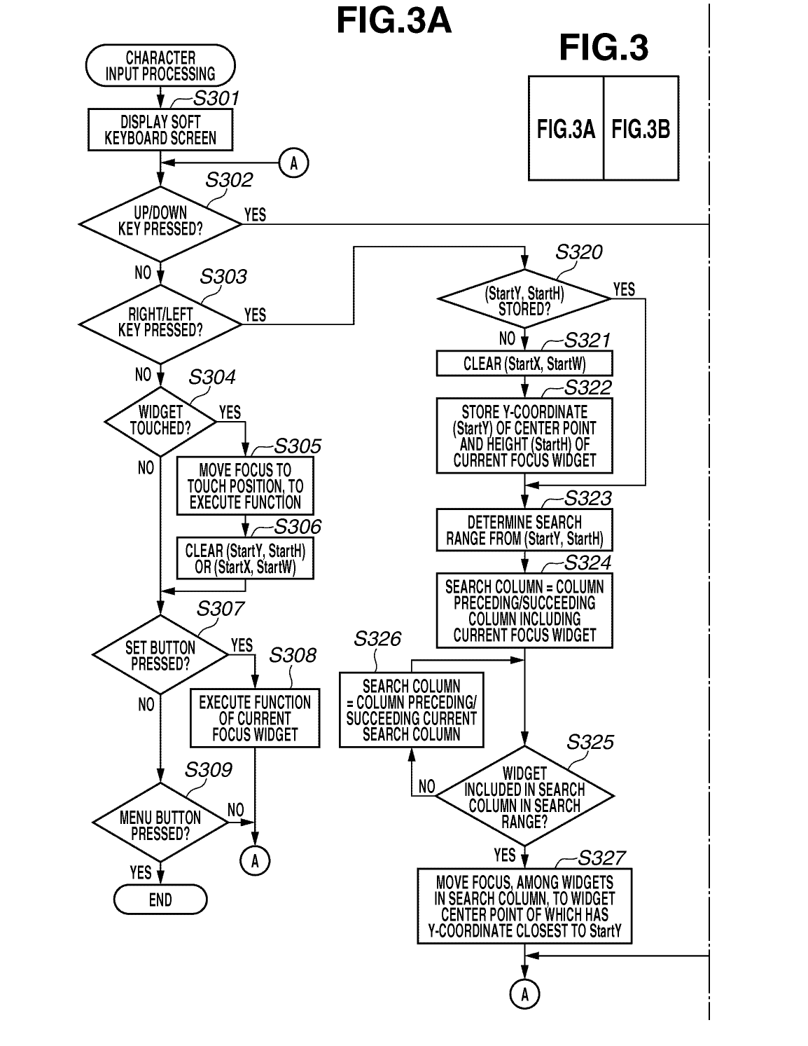

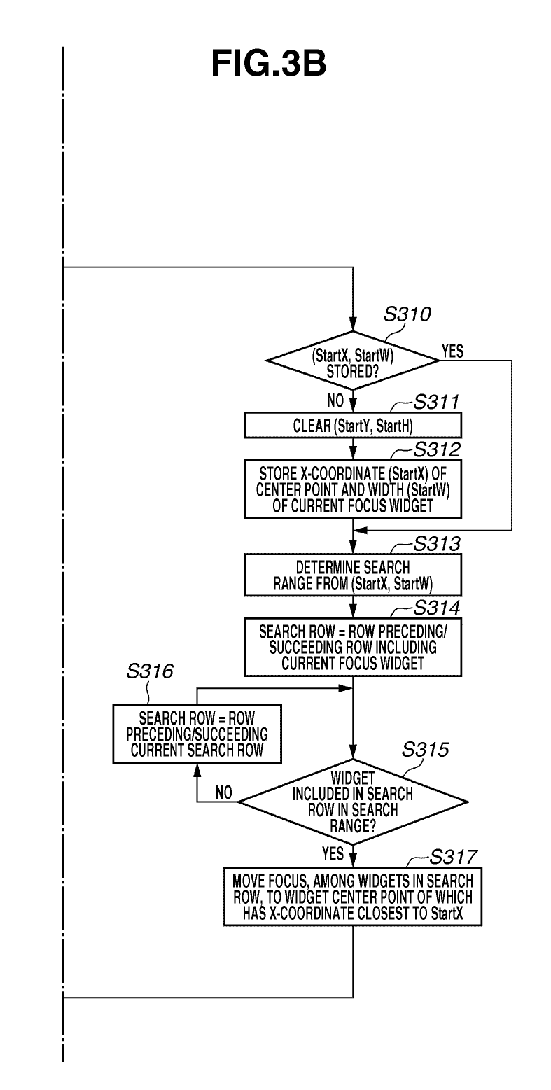

An operation according to each of exemplary embodiments of the present invention will be described below with reference to FIGS. 3 to 8.

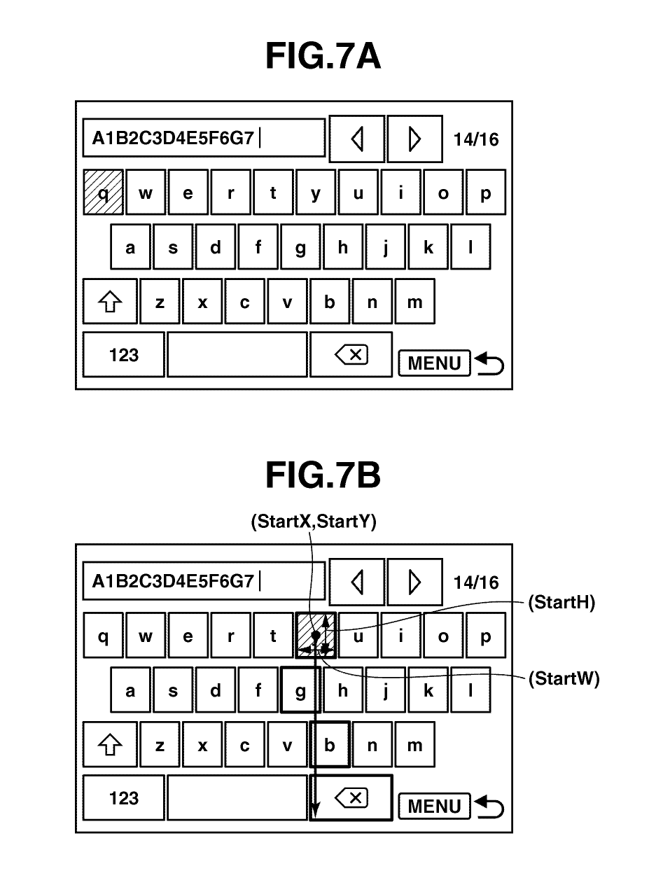

According to a first exemplary embodiment, an operation to input a key while a soft keyboard illustrated in FIG. 7A is displayed on the display unit 28 will be described below. In a state that the soft keyboard is displayed, character input processing is performed by selecting any of displayed input keys (GUI display items for respectively issuing instructions to execute functions such as a character input, a backspace, a space, a shift, and a character input position movement, which are referred to as widgets). The widgets in the soft keyboard are arranged to resemble a hardware keyboard, and are not aligned in a matrix. A widget in the succeeding row is not arranged directly below a widget arranged in a certain row. The widget in the succeeding row is arranged at a position shifted in a rightward or leftward direction. According to the first exemplary embodiment, a case where a selected focus is moved on the soft keyboard, and if an instruction to continuously move the selected focus in an upward and downward direction is issued, the focus movement is performed so as to reduce a shift from the widget which has first been focused on is described as an example.

FIG. 3 (including FIGS. 3A and 3B) is a flowchart of character input processing using the soft keyboard according to the first exemplary embodiment. The processing in the flowchart in FIG. 3 is implemented when the system control unit 50 rasterizes a program recorded on the nonvolatile memory 56 into the system memory 52 and executes the program.

When an instruction to display the soft keyboard is issued, the processing illustrated in FIG. 3 is started. The soft keyboard is displayed, for example, when a menu item for opening an input screen of a name of a photographer included in photographer information to be recorded as attribute information about a captured image in a menu screen displayed by operating the menu button 79 is designated.

In step S301, the system control unit 50 reads out each of the GUI components required to display the soft keyboard from the nonvolatile memory 56, and displays a soft keyboard screen as illustrated in FIG. 7A. The soft keyboard screen is displayed in a state where any one of the widgets is selected (a state where the widget is focused on). In an example illustrated in FIG. 7A, a widget “q” is focused on.

In step S302, the system control unit 50 determines whether the up/down key (either one of the up button 74 and the down button 75) is pressed. If it is determined that the up/down key is pressed (YES in step S302), the processing proceeds to step S310. Whereas if not (NO in step S302), the processing proceeds to step S303.

In step S303, the system control unit 50 determines whether the right/left key (either one of the right button 77 and the left button 76) is pressed. If it is determined that the right/left key is pressed (YES in step S303), the processing proceeds to step S320. Whereas if not (NO in step S303), the processing proceeds to step S304.

In step S304, the system control unit 50 determines whether a touch operation on a display position of any one of the widgets displayed on the display unit 28 is performed. More specifically, the system control unit 50 determines whether “touch-up” is performed from a position on the touch panel 73 corresponding to any one of the widgets. If it is determined that the touch operation on the widget is performed (YES instep S304), the processing proceeds to step S305. Whereas if not (NO in step S304), the processing proceeds to step S307.

In step S305, the system control unit 50 moves the focus to a widget (a fourth display item) at a position where “touch-up” is performed (a touch position immediately before “touch-up”), to perform a function of the widget at the “touch-up” position. More specifically, if “touch-up” from any one of widgets “a” to “z” is performed, a character of the widget from which “touch-up” is performed is input. If “touch-up” from each of widgets for a character input position movement, a shift, a switching to a numeric keyboard, a space, and a backspace, is performed, a corresponding function is executed.

In step S306, if either one of data sets (StartY, StartH) and (StartX, StartW) have still been retained (stored) in the system memory 52, the system control unit 50 clears (discards) them. The data sets (StartY, StartH) and (StartX, StartW) serve as a reference position which are retained (stored) in the system memory 52 in step S311 or S321, described below Thus, a reference position in a focus movement operation is reset. Thus, if the up/down key is pressed (a fourth instruction) after the reset, a movement destination of the focus is determined without being based on information about the reference position so far retained.

In step S307, the system control unit 50 determines whether the set button 78 is pressed. If it is determined that the set button 78 is pressed, i.e., an instruction to execute a function is issued (YES in step S307), the processing proceeds to step S308. Whereas if not (NO in step S307), the processing proceeds to step S309.

In step S308, the system control unit 50 executes a function of the widget that is focused on at the time point (a current focus widget, i.e., a display item currently selected). More specifically, if any one of the widgets “a” to “z” is focused on, a character of the current focus widget is input in response to the press of the set button 78. If the widget for a character input position movement, a shift, a switching into a numeric keyboard, a space, or a backspace is focused on, a function of the current focus widget is executed in response to the press of the set button 78. When the processing in step S308 ends, the processing returns to step S302.

In step S309, the system control unit 50 determines whether the menu button 79 is pressed. If it is determined that the menu button 79 is not pressed (NO in step S309), the processing returns to step S302. If it is determined that the menu button 79 is pressed (YES instep S309), the system control unit 50 determines a character string so far input, not to display a soft keyboard screen, and the character input processing ends.

On the other hand, if the up/down key is pressed (YES in step S302), the processing proceeds to step S310. In step S310, the system control unit 50 determines whether the data set (StartX, StartW) is retained in the system memory 52. The data set (StartX, StartW) retained in the system memory 52 is information that is cleared when the right/left key is pressed or the touch operation on the touch panel 73 is performed. More specifically, the processing in step S310 is a determination whether the up/down key is pressed again after the focus has been moved by the previous operation on the up/down key without being moved by pressing the right/left key or performing the touch operation. If it is determined that the data set (StartX, StartW) is retained in the system memory 52 (YES in step S310), the processing proceeds to step S313. Whereas if not (NO in step S310), the processing proceeds to step S311.

In step S311, the system control unit 50 clears (discards) the data set (StartY, StartH), if the data set is retained (stored) in the system memory 52. If the focus has been moved (a third display item has been displayed) by the previous operation on the right/left key, unlike that on the up/down key currently operated, a reference position in the focus movement is cleared once. Therefore, for example, if a widget has been previously selected in response to the operation on the up/down key, and then the up/down key is operated again (a third instruction) after the operation of the right/left key, a widget at a focus movement destination is determined, as described below, regardless of the reference position so far stored.

In step S312, an X-coordinate (StartX) of a central point and a width (StartW) of a widget that is currently focused on (a current focus widget) are retained as a reference position (stored in the system memory 52). FIG. 7B illustrates data pieces StartX, StartY, StartW, and StartH obtained when the current focus widget is a widget “y”. Coordinates of a central point of the widget “y” are (StartX, StartY), the width of the widget “y” is StartW, and the height of the widget “y” is StartH.

In step S313, the system control unit 50 determines a search range from the coordinate StartX and the width StartW which are retained in the system memory 52. More specifically, only a widget at least a part of which overlaps a range of the width StartW a central point of which has an X-coordinate of StartX is set to a search range (a focus movement destination candidate), and a widget not falling within the search range is excluded from the focus movement destination candidate.

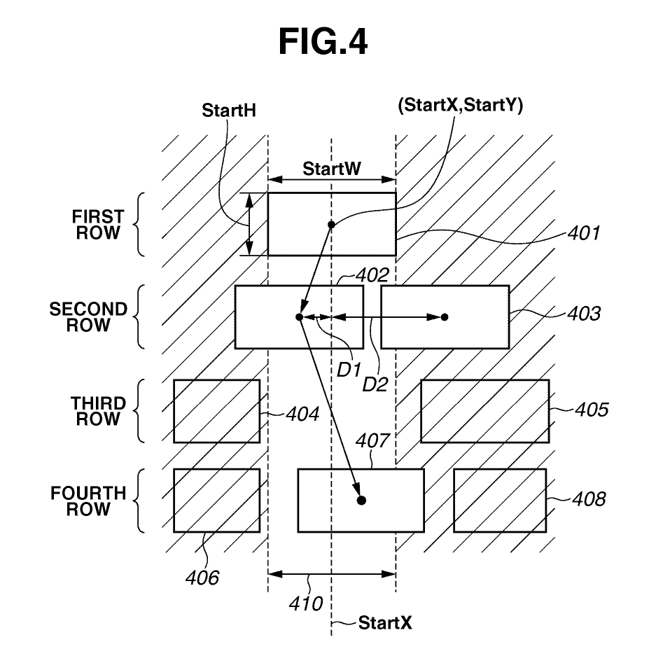

Setting of a search range will be described in detail with reference to FIG. 4. Widgets 401 to 408 are arranged side by side in first to fourth rows. At this time, it is assumed that a current focus widget (initial focus widget) obtained when the up/down key is first pressed is the widget 401. In this case, a range 410 of a width StartW a central point of which has an X-coordinate of StartX is a search range. The widgets 402, 403, and 407 at least a part of which overlaps the range 410 fall within the search range 410, and the other widgets 404, 405, 406, and 408 are excluded from the focus destination movement candidate.

If it is determined that the data set (StartY, StartH) is retained (YES in step S310), the processing in steps S311 and S312 is skipped. As a result, a search range is the same as the previous one, and if an operation in the same axial direction is continued, the search range is not changed.

In step S314, the system control unit 50 then sets a search row. If the button pressed in step S302 is the up button 74, the search row is set to a row that is one row above (in a third direction) a row including the current focus widget. If there is no row above the row including the current focus widget, the search row is set to the lowermost row at an opposite end. On the other hand, if the button pressed in step S302 is the down button 75, the search row is set to a row that is one row below (in a first direction) the row including the current focus widget. If there is no row below the row including the current focus widget, the search row is set to the uppermost row at an opposite end.

In step S315, the system control unit 50 determines whether there is a widget in the set search range and the set search row. If the current focus widget is the widget 401 in FIG. 4, for example, and when the down button 75 is pressed, the widget 402 and the widget 403 exist in the search range 410 in a row (a second row) which is one row below the row including the current focus widget, set as a search row. Therefore, it is determined YES in step S315. In addition, if the current focus widget is the widget 402 in FIG. 4, for example, there exists no widget in the search range 410 in a row (a third row) which is one row below a row including the current focus widget, set as a search row (when the initial focus widget is the widget 401). Therefore, it is determined NO instep S315 in this case. If it is determined that there is a widget (YES in step S315), the processing proceeds to step S317. If there is no widget (NO in step S315), the processing proceeds to step S316.

In step S316, the system control unit 50 sets the search row one row ahead, and the processing proceeds to step S315 again. More specifically, if the button pressed in step S302 is the up button 74, the search row is set to a row that is one row above the current search row. If there is no row above the current search row, the search row is set to the lowermost row at an opposite end. On the other hand, if the button pressed in step S302 is the down button 75, the search row is set to a row that is one row below the current search row. If there is no row below the current search row, the search row is set to the uppermost row at an opposite end. If the search row is the third row in FIG. 4, for example, there exists no widget in the search range 410. Therefore, in step S316, the system control unit 50 sets the search row to the fourth row, and the processing proceeds to step S315 again. Consequently, the widget 407 exists in the search range 410 in the fourth row serving as the search row this time. Therefore, it is determined YES in step S315.

In step S317, the system control unit 50 moves the focus, among the widgets existing in the search range 410 in the search row, to the widget a central point of which has an X-coordinate closest to the coordinate StartX. When the down button 75 is pressed while the current focus widget before the focus movement is the widget 401 in FIG. 4, for example, the widget 402 and the widget 403 exist in the search range 410 in the second row serving as the search row. A distance D1 between a central point of the widget 402 and the coordinate StartX is shorter (closer) than a distance D2 between a central point of the widget 403 and the coordinate StartX. Therefore, the focus is moved to the widget 402 in this case. When the processing in step S317 ends, the processing proceeds to step S302. The processing in step S302 and the subsequent steps are repeated.

On the other hand, steps S320 to S327 that are processing performed when it is determined that the right/left key is pressed in step S303 are similar to steps S310 to S317 that are the processing performed when the up/down key is pressed by replacing “top and down” key with “right and left” key.

More specifically, in step S320, the system control unit 50 determines whether the data set (StartY, StartH) is retained in the system memory 52. The data set (StartY, StartH) retained in the system memory 52 is information that is cleared when the up/down key is pressed or the touch operation on the touch panel is performed. More specifically, the processing in step S320 is a determination whether the right/left key is pressed again after the focus has been moved by the previous operation on the right/left key without being moved by pressing the up/down key or performing the touch operation. If it is determined that the data set (StartY, StartH) is retained in the system memory 52 (YES in step S320), the processing proceeds to step S323. Whereas if not (NO in step S320), the processing proceeds to step S321.

In step S321, the system control unit 50 clears (discards) the data set (StartX, StartW). if the data set is retained (stored) in the system memory 52. If the focus has been moved by the previous operation on the up/down key, unlike that on the right/left key currently operated, the reference position in the focus movement is cleared once.

In step S322, the system control unit 50 retains (stores in the system memory 52) a Y-coordinate (StartY) of a central point and a height (StartH) of a widget (a current focus widget) that is currently being focused on.

In step S323, the system control unit 50 determines a search range from the coordinate StartY and the height StartH that are retained in the system memory 52. More specifically, only a widget at least a part of which overlaps a range of the height StartH a central point of which has a Y-coordinate of StartY is set to a search range (a focus movement destination candidate), and a widget not falling within the search range is excluded from the focus movement destination candidate.

Instep S324, the system control unit 50 sets a search column. If the button pressed in step S303 is the left button 76, the search column is set to a column that is one column at the left (in a second direction) of a column including the current focus widget. If there is no column at the left of the column including the current focus widget, the search column is set to the rightmost column at an opposite end. On the other hand, if the button pressed in step S303 is the right button 77, the search column is set to a column that is one column at the right (in a fourth direction) of the column including the current focus widget. If there is no column at the right of the column including the current focus widget, the search column is set to the leftmost column at an opposite end.

In step S325, the system control unit 50 determines whether there is a widget in the set search range and the set search column. If there is a widget (YES in step S325), the processing proceeds to step S327. If there is no widget (NO in step S325), the processing proceeds to step S326.

In step S326, the system control unit 50 sets the search column one column ahead, and the processing proceeds to step S325 again. More specifically, if the button pressed in step S303 is the left button 76, the search column is set to a column that is one column at the left of the current search column. If there is no column at the left of the current search column, the search column is set to the rightmost column at an opposite end. On the other hand, if the button pressed in step S303 is the right button 77, the search column is set to a column that is one column at the right of the current search column. If there is no column at the right of the current search column, the search column is set to the leftmost column at an opposite end.

In step S327, the system control unit 50 moves the focus, among widgets existing in the search range in the search column, to the widget a central point of which has a Y-coordinate closest to the coordinate StartY. When the processing in step S327 ends, the processing proceeds to step S302. The processing in step S302 and the subsequent steps are repeated.

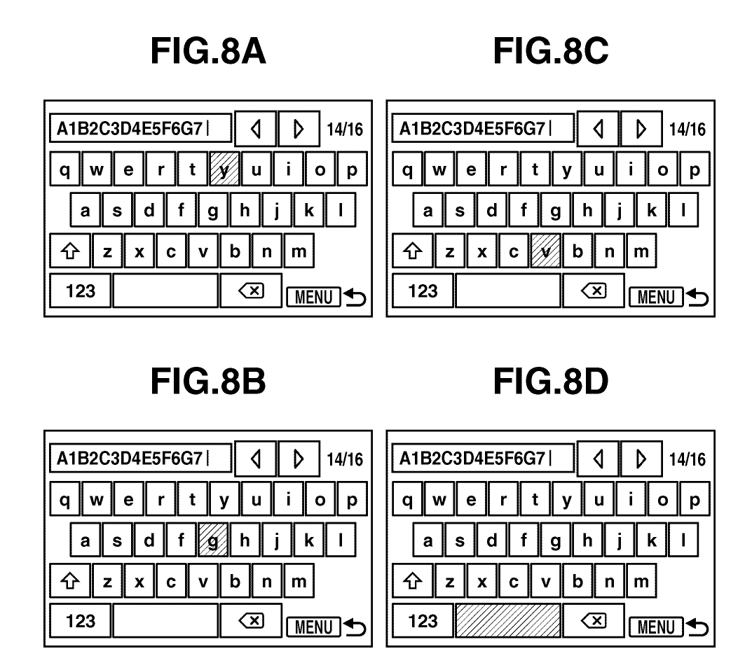

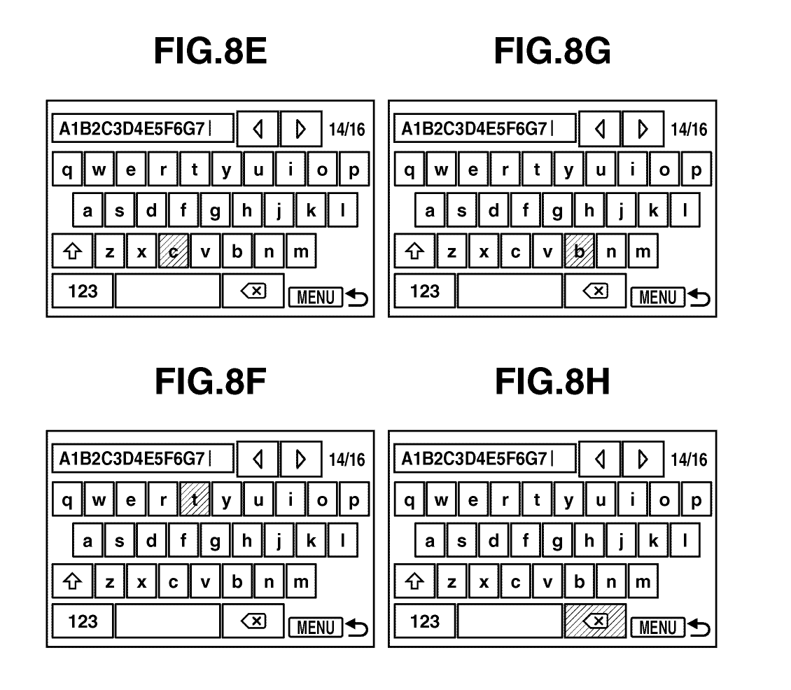

In the soft keyboard illustrated in FIG. 8A, widgets are aligned in a rightward and leftward direction. Therefore, utility of processing in steps S320 to S327 corresponding to the operation on the right/left key is low. However, the processing is not unnatural because it takes a general behavior of moving a focus to an adjacent item on the same axis.

A specific example of the focus movement performed when the processing illustrated in FIG. 3 is performed with the widget “y” (hereinafter referred to as a “y” key. The same is true for the other widgets) as a starting point will be described with reference to FIGS. 8A to 8H.

FIG. 8A illustrates an example of display performed when the “y” key is focused on. When the down button 75 is pressed from this state, the coordinate StartX and the width StartW of the “y” key are retained (in step S312), and a search range of the “y” key is determined. In the example illustrated in FIG. 8A, widgets falling within the search range of the “y” key include a “g” key, a “h” key, a “v” key, a “b” key, a space key, a back space key, and a leftward character input position movement key. A row that is one row below a row including the “y” key which is focused on is set to a search row (in step S314). Since the “g” key and the “h” key exist in the search row, it is determined YES in step S315. Among the “g” key and the “h” key, the “g” key close to the center of the “y” key having an X-coordinate of StartX is set to the succeeding current focus widget, and the focus is moved to the “g” key in step S317. FIG. 8B illustrates an example of display performed when the focus is moved to the “g” key.

When the down button 75 is further continuously pressed, the focus is moved, out of the “v” key and the “b” key falling within the search range in a row (a search row) that is one row below the row including the “g” key, to the “b” key close to the center of the “y” key having an X-coordinate of StartX. FIG. 8G illustrates an example of display performed when the focus is moved to the “b” key.

When the down button 75 is further continuously pressed, the focus is moved, among the space key and the back space key falling within the search range in a row (search row) that is one row below the row including the “b” key, to the back space key close to the center of the “y” key having an X-coordinate of StartX. FIG. 8H illustrates an example of display performed when the focus is moved to the back space key.

When the down button 75 is further continuously pressed, there is no row below the row including the back space key. Therefore, the focus is moved to the leftward character input position movement key falling within the search range in the uppermost row (search row) at an opposite end. When the down button 75 is further continuously pressed, the focus is moved to the “y” key included in the search range in a row (search row) that is one row below the uppermost row.

As described above, if the widgets are not aligned in an upward and downward direction, the focus is moved using a center axis (StartX) of the “y” key, which has been focused on when an operation in a downward direction is started, as a reference. When the down button 75 is pressed a plurality of times, therefore, the focus can return to the “y” key again.

When the up button 74 in an opposite direction to the down button 75 is continuously pressed three times from a state where the focus has been moved to the back space key by pressing the down button 75 (FIG. 8H) without pressing the right/left key or performing the touch operation with the “y” key as a starting point, the focus is moved as follows:

Back space key (FIG. 8H)→“b” key (FIG. 8G)→“g” key (FIG. 8B)→“y” key (FIG. 8A)

If the operation on the same axis (the press of the up/down key) is thus performed, the focus can return to the position of the “y” key at the start of the operation.

Thus, according to the present exemplary embodiment, a center position of the focus widget at the start of the press of the up/down key is retained, and the focus is moved based on the center position first retained as long as it is not moved by pressing the right/left key or performing the touch operation. Therefore, the focus movement can be performed without being shifted in axis. More specifically, when the focus movement is started in a certain direction (e.g., a downward direction), and is then continued in the same axial direction (e.g., an upward and downward direction), the focus is moved so that a distance from the center axis of not the previous focus position but the first focus position is shortened. Thus, the widget which has been selected once can be prevented from not being selected despite performing only the focus movement in the same axial direction. In other words, according to the present invention, the display item previously selected in a continuous operation process in the same axial direction can be selected again from among the plurality of display items by an operation in the same axial direction without performing an operation in another axial direction. If an instruction to perform selective switching in the same axial direction is continuously issued, selective switching which is hardly shifted from a position of the display item first selected can be performed.

According to the first exemplary embodiment, an example in which the search row is set for each row or the search column is set for each column to search for a widget serving as a focus movement destination is described. However, the processing illustrated in FIG. 3 described according to the first exemplary embodiment is not easily applied to a case where a plurality of widgets is arranged in a dispersed manner without being aligned in a matrix. According to a second exemplary embodiment, a method for performing focus movement will be described which can move a focus with little shift from a position which has first been focused on in response to an instruction to continuously move the focus a plurality of times in a single axial direction even if a plurality of widgets is aligned in a dispersed manner without being aligned in a matrix.

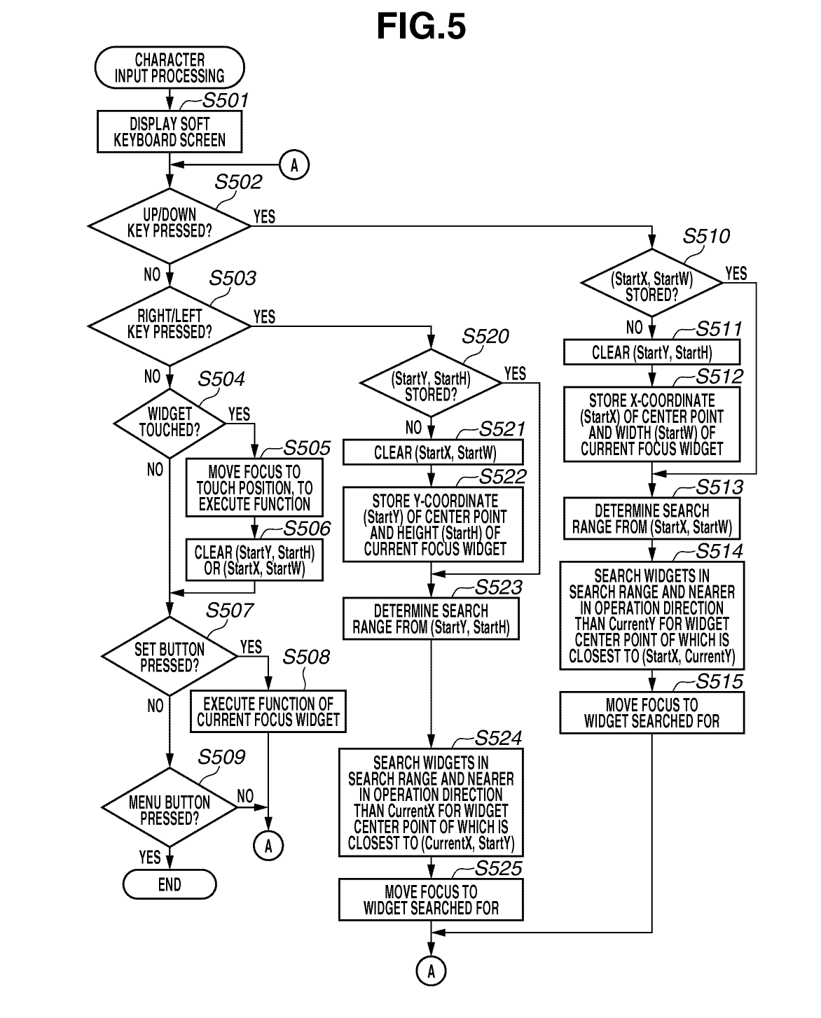

FIG. 5 is a flowchart of character input processing using a soft keyboard in the second exemplary embodiment. The processing in the flowchart in FIG. 5 is implemented when the system control unit 50 rasterizes a program recorded on the nonvolatile memory 56 into the system memory 52 and executes the program.

When the instruction to display the soft keyboard is issued, the processing illustrated in FIG. 5 is started.

Since the processing in steps S501 to S513 is similar to the processing in steps S301 to S313 illustrated in FIG. 3, described above, and hence description thereof is not repeated.

In step S514, the system control unit 50 searches widgets falling within the search range determined in step S513 (which is set, like in step S313 according to the first exemplary embodiment) for the widget at the subsequent focus movement destination according to an operation on the up/down key. More specifically, the system control unit 50 searches the widgets in the search range and nearer in a direction in which the up/down key is operated than a Y-coordinate (CurrentY) of a central point of a current focus widget for the widget a central point of which is closest to coordinates (StartX, CurrentY). If there is no widget in the search range and nearer in the direction in which the up/down key is operated than the Y-coordinate (CurrentY) of the central point of the current focus widget, a Y-coordinate at an opposite end of a display area of the display unit 28 is searched for as the coordinate CurrentY.

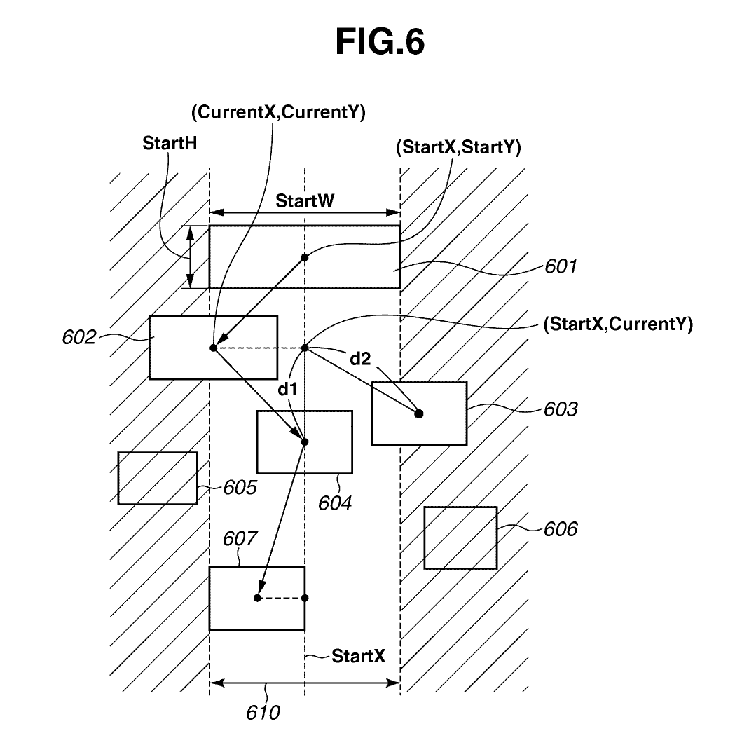

A method for searching for a widget in step S514 will be described with reference to FIG. 6. In an example illustrated in FIG. 6, widgets 601 to 607 are arranged in a dispersed manner without being aligned. At this time, it is assumed that an initial focus widget is the widget 601 when the up/down key is first pressed. In this case, a range 610 of a width StartW a central point of which has an X-coordinate of StartX is a search range. The widgets 602, 603, 604, and 607 at least a part of which overlaps the range 610 fall within the search range 610, and the other widgets 605 and 606 are excluded from a focus movement destination candidate. In this situation, a method for searching for the focus movement destination when the down button 75 is pressed from a state where the current focus widget is the widget 602, i.e., a state where coordinates (CurrentX, CurrentY) are coordinates of a central point of the widget 602 will be described.

The three widgets 603, 604, and 607 fall within the search range 610 and are arranged in the downward direction corresponding to the pressed down button 75 than the Y-coordinate (CurrentY) of the central point of the current focus widget. Among the widgets 603, 604, and 607, the widget the central point of which is closest to the coordinates (StartX, CurrentY) is the widget 604. Therefore, the widget 604 is the widget at the focus movement destination to be searched for.

For example, a distance d1 between the coordinates (StartX, CurrentY) and the central point of the widget 604 is shorter than a distance d2 between the coordinates (StartX, CurrentY) and a central point of the widget 603. Thus, the focus movement destination in the downward direction from the widget 602 is not the widget 603 but the widget 604 (the widget 604 is determined as the focus movement destination).

As another example, if the down button 75 is pressed from a state where the current focus widget is the widget 607, there is no widget below the current focus widget. Thus, a Y-coordinate at an uppermost end of the display unit 28 at an opposite end is searched for as the coordinate CurrentY. Therefore, the widget 601 is searched for (the widget 601 is determined as the focus movement destination) in this case.

Instep S515, the system control unit 50 moves a focus to the widget which is searched for in step S514, and the processing proceeds to step S502.

The processing in steps S520 to S523 is similar to the processing in steps S320 to S323 illustrated in FIG. 3, described above, and hence description thereof is not repeated.

In step S524, the system control unit 50 searches widgets falling within the search range determined in step S523 (which is set, like in step S323 according to the first exemplary embodiment) for the widget at the subsequent focus movement destination according to an operation on the right/left key. More specifically, the system control unit 50 searches the widgets in the search range and nearer in the direction in which the right/left key is operated than an X-coordinate (CurrentX) of a central point of a current focus widget for the widget a central point of which is closest to the coordinates (CurrentX, StartY).

In step S525, the system control unit 50 moves a focus to the widget, which is searched for in step S524, and the processing proceeds to step S502.

The processing illustrated in FIG. 5 enables focus movement which is hardly shifted from a position that has first been focused on, to be performed in response to a focus movement instruction continuously issued in a single axial direction even if the widgets are arranged in a dispersed manner, as in the example illustrated in FIG. 6. The processing illustrated in FIG. 5 is also applicable to a case where any one of options aligned for each row illustrated in FIG. 8, described above, is selected.

A specific example of the focus movement performed when the processing illustrated in FIG. 5 is performed with the widget “y” (hereinafter referred to as a “y” key. The same is true for the other widgets) as a starting point will be described with reference to FIGS. 8A to 8H.

FIG. 8A illustrates an example of display performed when the “y” key (a first display item) is focused on. When the down button 75 is pressed (a first instruction is issued) from this state, the coordinate StartX and the width StartW of the “y” key are retained (in step S512), and a search range of the “y” key is determined. In the example illustrated in FIG. 8A, widgets falling within the search range of the “y” key include the “g” key, the “h” key, the “v” key, the “b” key, the space key, the back space key, and the leftward character input position movement key. Among the widgets, the widgets falling within the search range and nearer in the downward direction (a first direction) corresponding to the pressed button 75 than the coordinate CurrentY (which is the same in value as the coordinate StartY in this case) are the “g”, “h”, “v”, and “b” keys, the space key, and the back space key. Among the widgets, the widget the central point of which is closest to the coordinates (StartX, CurrentY) is the “g” key. Therefore, the focus is moved from the “y” key to the “g” key (a second display item), as illustrated in FIG. 8B.

When the down button 75 is further continuously pressed (a second instruction has been issued), the state changed as follows. The widgets falling within the search range and nearer in the downward direction corresponding to the down button 75 than the coordinate CurrentY (a Y-coordinate of the central point of the “g” key) are the “v” key, the “b” key, the space key, and the back space key. Among the widgets, the widget the central point of which is closest to the coordinates (StartX, CurrentY) is the “b” key. Therefore, the focus is moved from the “g” key to the “b” key (a fifth display item), as illustrated in FIG. 8G.

When the down button 75 is further continuously pressed, the widgets falling within the search range and nearer in the downward direction corresponding to the pressed down button 75 than the coordinate CurrentY (a Y-coordinate of the central point of the “b” key) is the space key and the back space key. Among the widgets, the widget the central point of which is closest to the coordinates (StartX, CurrentY) is the back space key. Therefore, the focus is moved from the “b” key to the back space key, as illustrated in FIG. 8H.

When the down button 75 is further continuously pressed, there is no widget below the back space key. In this case, a Y-coordinate at an uppermost end serving as an opposite end is the coordinate CurrentY, and the focus is moved to the leftward character input position movement key falling within the search range and closest to the coordinates (StartX, CurrentY). When the down button 75 is further continuously pressed, the focus is moved to the “y” key nearer in the downward direction than the coordinate CurrentY (a Y-coordinate of the leftward character input position movement key) and the central point of which is closest to the coordinates (StartX, CurrentY).

When the widgets are thus arranged in a dispersed manner, the focus is moved using a center axis (StartX) of the “y” key which has been focused on immediately before an operation in the downward direction is started, as a reference. When the down button 75 is pressed a plurality of times, therefore, the focus can return to the “y” key again.

When the up button 74 is continuously pressed three times from a state where the focus has been moved to the back space key by an operation on the up/down key (FIG. 8H) without pressing the right/left key or performing the touch operation with the “y” key as a starting point, the focus is moved as follows:

Back space key (FIG. 8H)→“b” key (FIG. 8G)→“g” key (FIG. 8B)→“y” key (FIG. 8A)

Unless an operation in another axial direction or an operation for directly designating a display item, e.g., a touch operation is performed, if the operation on the same axis (the press of the up/down key) is performed, the focus can return to the position of the “y” key at the start of the operation.

As described above, according to the present exemplary embodiment, a center position of the focus widget at the start of the press of the up/down key is retained, and the focus is moved based on the center position first retained as long as it is not moved by pressing the right/left key or performing the touch operation. Therefore, the focus movement can be performed without being shifted in axis. More specifically, when the focus movement is started in a certain direction (e.g., a downward direction), and is then continued in the same axial direction (e.g., an upward and downward direction), the focus is moved based on the center axis of not the previous focus position but the first focus position. Thus, the widget which has been selected once can be prevented from not being selected despite performing only the focus movement in the same axial direction. In other words, according to the present exemplary embodiment, the display item previously selected in a continuous operation process in the same axial direction can be selected again from among the plurality of display items by an operation in the same axial direction without performing an operation in another axial direction. If an instruction to perform selective switching in the same axial direction is continuously issued, selective switching which is hardly shifted from a position of the display item first selected can be performed.

In each of the above-described exemplary embodiments, an example in which the present invention is applied in a scene on which a key displayed on the soft keyboard is selected is described. However, the present invention is not limited to such example. The present invention is applicable to a scene on which a selected focus is moved while the plurality of widgets (display items) is arranged. For example, the present invention is applicable when the widget (display item) is a displayed image (or a thumbnail of the image), and any one of a plurality of images which are displayed is selected on a screen on which the images are simultaneously displayed. The widget (display item) may include various types of icons such as an icon representing a file, an icon representing a folder, and an icon representing an application, selectable graphics data, a display window, a dialog, a virtual button, and a hyperlink.

The control described as performed by the system control unit 50 in each of the above-described exemplary embodiments may be performed by one hardware as described above. Alternatively, a plurality of pieces of hardware may perform control of the entire apparatus by sharing processing.

While the present invention is applied to the digital camera 100 in each of the above-described exemplary embodiments, the present invention is not limited to this example. The present invention is also applicable to a display control apparatus capable of displaying a plurality of selectable display items and selecting any one of the display items. More specifically, the present invention is applicable to a personal computer, personal digital assistants (PDA), a mobile phone terminal, a portable image viewer, a printer apparatus including a display, a digital photo frame, a music player, a game machine, an electronic book reader, and so on.

Aspects of the present invention can also be realized by a computer of a system or apparatus (or devices such as a CPU or an MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention is described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Patent Application No. 2012-155510 filed Jul. 11, 2012, which is hereby incorporated by reference herein in its entirety.

What is claimed is:

1. A display control apparatus comprising:
a display control unit configured to display a plurality of selectable display items side by side for each row;
a receiving unit configured to be able to receive an instruction to switch, from among the plurality of display items, selection from a display item currently selected to another display item in a first direction parallel to a first axial direction and an instruction to switch the selection from the display item currently selected to another display item in a second direction parallel to a second axial direction not parallel to the first axial direction; and
a control unit configured to perform control to, in a case where a first instruction to switch the selection to the first direction is issued, from among display items included in a row succeeding a row in which a first display item which is selected before the first instruction is received is displayed, select a second display item a position in the second axial direction of which is closest to a position in the second axial direction of the first display item, and in a case where a second instruction to switch the selection to the first direction is issued without an instruction to switch the selection to the second direction being issued from a state where the second display item is selected in response to the first instruction, select a display item a position in the second axial direction of which is closest to a position in the second axial direction of the first display item from among the display items included in a row succeeding a row in which the second display item is displayed.

2. A display control apparatus comprising:
a display control unit configured to display a plurality of selectable display items;
a receiving unit configured to be able to receive an instruction to switch, among the plurality of display items, selection from a display item currently selected to another display item in a first direction and an instruction to switch the selection from the display item currently selected to another display item in a second direction not parallel to the first direction; and
a control unit configured to perform control to, in a case where a first instruction to switch the selection to the first direction is issued, from among display items nearer in the first direction than a first display item that is selected before the first instruction is received, switch the selection to a second display item determined based on a position of the first display item, and in a case where a second instruction to switch the selection to the first direction is issued without an instruction to switch the selection to the second direction being issued from a state where the second display item is selected in response to the first instruction, switch the selection to a display item determined based on the position of the first display item from among the display items nearer in the first direction than the second display item.

3. The display control apparatus according to claim 2, wherein the control unit performs control to, in a case where the first instruction is issued, switch the selection to the second display item determined based on a position of the first display item in a second axial direction parallel to the second direction from among the display items nearer in the first direction than the first display item, and in a case where the second instruction is issued without the instruction to switch the selection to the second direction being issued from the state where the second display item is selected in response to the first instruction, switch the selection to a display item determined based on the position in the second axial direction of the first display item from among the display items nearer in the first direction than the second display item.

4. The display control apparatus according to claim 2, wherein the control unit performs control to, in a case where the first instruction is issued, switch the selection to a second display item closest to the first display item from among the display items nearer in the first direction than the first display item and at least a part of which overlaps a range having a width of the first display item in a second axial direction parallel to the second direction, and in a case where the second instruction is issued without the instruction to switch the selection to the second direction being issued from the state where the second display item is selected in response to the first instruction, select a display item closest to a point represented by a position of the second display item in a first axial direction parallel to the first direction and a position in the second axial direction of the first display item from among the display items nearer in the first direction than the second display item and at least a part of which overlaps the range.

5. A display control apparatus comprising:
a display control unit configured to display a plurality of selectable display items;
a receiving unit configured to be able to receive an instruction to switch, from among the plurality of display items, selection from a display item currently selected to another display item in a first direction parallel to a first axial direction and an instruction to switch the selection from the display item currently selected to another display item in a second direction parallel to a second axial direction not parallel to the first axial direction; and
a control unit configured to perform control to, in a case where a first instruction to switch the selection to the first direction is issued, from among display items nearer in the first direction than a first display item that is selected before the first instruction is received and at least a part of which overlaps a range having a width in the second axial direction of the first display item, switch the selection to a second display item closest to the first display item, and in a case where a second instruction to switch the selection to the first direction is issued without the instruction to switch the selection to the second direction being issued from a state where the second display item is selected in response to the first instruction, select a display item closest to a point represented by a position in the first axial direction of the second display item and a position in the second axial direction of the first display item from among the display items nearer in the first direction than the second display item and at least a part of which overlaps the range.

6. The display control apparatus according to claim 2, wherein the control unit performs control to, in a case where a third instruction to switch the selection to the first direction from a state where a third display item is selected in response to the instruction to switch the selection to the second direction after the second display item is selected in response to the first instruction, switch the selection to a display item determined regardless of the position of the first display item.

7. The display control apparatus according to claim 6, wherein the control unit performs control to, in a case where the third instruction is issued, switch the selection to a display item determined based on a position of the third display item in a second axial direction parallel to the second direction from among the display items nearer in the first direction than the third display item.

8. The display control apparatus according to claim 2,
wherein the receiving unit is capable of further receiving a touch operation on any one of display positions of the plurality of display items, and
wherein the control unit performs control to, in a case where the touch operation is performed after the second display item is selected in response to the first instruction, switch the selection to a fourth display item displayed at a position where the touch operation is performed, and in a case where a fourth instruction to switch the selection to the first direction from a state where the fourth display item is selected in response to the touch operation, switch the selection to a display item determined regardless of the position of the first display item.

9. The display control apparatus according to claim 8, wherein, in a case where the fourth instruction is issued, the control unit performs control to switch the selection to a display item determined based on a position of the fourth display item in a second axial direction parallel to the second direction from among the display items nearer in the first direction than the fourth display item.

10. The display control apparatus according to claim 2, wherein, in a case where the second instruction is issued without the instruction to switch the selection to the second direction being issued after a function represented by the second display item is executed in response to an instruction to execute the function from the state where the second display item is selected in response to the first instruction, the control unit also performs control to switch the selection to a display item determined based on the position of the first display item.

11. The display control apparatus according to claim 2,
wherein the receiving unit is capable of further receiving an instruction to switch the selection from the display item currently selected to another display item in a third direction parallel to and opposite to the first direction from among the plurality of display items, and
wherein the control unit performs control to, in a case where an instruction to switch the selection to the third direction is issued without the instruction to switch the selection to the second direction being issued from a state where a fifth display item is selected in response to the second instruction, switch the selection to a display item determined based on the position of the first display item.

12. The display control apparatus according to claim 2, wherein the display control unit performs control to display the plurality of display items without aligning the display items in a matrix.

13. The display control apparatus according to claim 2, wherein, if there is no display item to be selected nearer in the first direction than the second display item in a case where the second instruction is issued, the control unit performs control to switch the selection to a display item determined based on the position of the first display item from among the display items in the first direction from an end in a direction opposite to the first direction in a display area.

14. The display control apparatus according to claim 2, wherein, if there is no display item at least a part of which overlaps a range having a width in a second axial direction parallel to the second direction of the first display item in a row succeeding a row in which the second display item is displayed in a case where the second instruction is issued, the control unit performs control to select a display item a position in the second axial direction of which is closest to a position in the second axial direction of the first display item from among the display items included in the further succeeding row.

15. The display control apparatus according to claim 2, wherein the plurality of display items represents input keys included in a soft keyboard for character input.

16. The display control apparatus according to claim 2, further comprising a cross key serving as an operation member capable of issuing an instruction in four upward, downward, rightward, and leftward directions,
wherein the receiving unit receives an instruction to switch the selection to another display item in the first direction in response to an upward or downward operation for the cross key, and receives an instruction to switch the selection to another display item in the second direction in response to a rightward or leftward operation for the cross key.

17. The display control apparatus according to claim 2, wherein the display control apparatus is an image capturing apparatus including an image capturing unit.

18. The display control apparatus according to claim 2, further comprising a storage control unit configured to perform control to store in a memory a position of a selected display item in a second axial direction parallel to the second direction,
wherein the storage control unit does not clear, even if an instruction to switch the selection to the first direction is issued, the position of the display item in the second axial direction stored in the memory.

19. The display control apparatus according to claim 18, wherein the storage control unit clears the position of the display item in the second axial direction stored in the memory after the selection is switched to the second direction.

20. The display control apparatus according to claim 2, wherein the first direction is parallel to a Y-axis, and the second direction is parallel to an X-axis.

21. A display control apparatus comprising:
a display control unit configured to display a plurality of selectable display items;
a receiving unit configured to be able to receive an instruction to switch, among the plurality of display items, selection from a display item currently selected to another display item in a first direction and an instruction to switch the selection from the display item currently selected to another display item in a second direction not parallel to the first direction;
a storage control unit configured to perform control to store in a memory a position of a first display item selected at a predetermined time point in a second axial direction parallel to the second direction; and
a control unit configured to perform control to switch the selection to a display item determined based on a position in the second axial direction of the first display item stored by the storage control unit, in response to an instruction to switch the selection to the first direction, from among the display items nearer in the first direction than the display item that is selected before the instruction is received,
wherein the storage control unit does not clear the position of the first display item in the second axial direction stored in the memory even if the instruction to switch the selection to the first direction is issued.

22. A method for controlling a display control apparatus, the method comprising:
displaying a plurality of selectable display items;
receiving an instruction to switch, from among the plurality of display items, selection from a display item currently selected to another display item in a first direction parallel to a first axial direction and an instruction to switch the selection from the display item currently selected to another display item in a second direction parallel to a second axial direction not parallel to the first axial direction; and
performing control to, in a case where a first instruction to switch the selection to the first direction is issued, from among display items included in a row succeeding a row in which a first display item which is selected before the first instruction is received is displayed, select a second display item a position in the second axial direction of which is closest to a position in the second axial direction of the first display item; and
performing control to, in a case where a second instruction to switch the selection to the first direction is issued without an instruction to switch the selection to the second direction being issued from a state where the second display item is selected in response to the first instruction, select a display item a position in the second axial direction of which is closest to a position in the second axial direction of the first display item from among the display items included in a row succeeding a row in which the second display item is displayed.

23. A method for controlling a display control apparatus, the method comprising:
displaying a plurality of selectable display items;
receiving an instruction to switch, among the plurality of display items, selection from a display item currently selected to another display item in a first direction and an instruction to switch the selection from the display item currently selected to another display item in a second direction not parallel to the first direction;
performing control to, in a case where a first instruction to switch the selection to the first direction is issued, from among display items nearer in the first direction than a first display item that is selected before the first instruction is received, switch the selection to a second display item determined based on a position of the first display item; and
performing control to, in a case where a second instruction to switch the selection to the first direction is issued without an instruction to switch the selection to the second direction being issued from a state where the second display item is selected in response to the first instruction, switch the selection to a display item determined based on the position of the first display item from among the display items nearer in the first direction than the second display item.

24. A method for controlling a display control apparatus, the method comprising:
displaying a plurality of selectable display items;
receiving an instruction to switch, from among the plurality of display items, selection from a display item currently selected to another display item in a first direction parallel to a first axial direction and an instruction to switch the selection from the display item currently selected to another display item in a second direction parallel to a second axial direction not parallel to the first axial direction; and
performing control to, in a case where a first instruction to switch the selection to the first direction is issued, from among display items nearer in the first direction than a first display item that is selected before the first instruction is received and at least a part of which overlaps a range having a width in the second axial direction of the first display item, switch the selection to a second display item closest to the first display item; and
performing control to, in a case where a second instruction to switch the selection to the first direction is issued without the instruction to switch the selection to the second direction being issued from a state where the second display item is selected in response to the first instruction, select a display item closest to a point represented by a position in the first axial direction of the second display item and a position in the second axial direction of the first display item from among the display items nearer in the first direction than the second display item and at least a part of which overlaps the range.

25. A method for controlling a display control apparatus, the method comprising:
displaying a plurality of selectable display items;
receiving an instruction to switch, among the plurality of display items, selection from a display item currently selected to another display item in a first direction and an instruction to switch the selection from the display item currently selected to another display item in a second direction not parallel to the first direction;
performing control to store in a memory a position of a first display item selected at a predetermined time point in a second axial direction parallel to the second direction;
performing control to switch the selection to a display item determined based on a position in the second axial direction of the first display item stored by the storage control, in response to an instruction to switch the selection to the first direction, from among the display items nearer in the first direction than the display item that is selected before the instruction is received;
wherein the storage control does not clear the position of the first display item in the second axial direction stored in the memory even if the instruction to switch the selection to the first direction is issued.

26. A non-transitory computer readable storage medium storing a program for causing a computer to function as each of units in the display control apparatus according to claim 1.
